(19) United States
(12) Patent Application Publication
(10) Pub. No.: US 2003/0212791 A1
(43) Pub. Date: Nov. 13, 2003

(54) Method and system for authorising electronic mail

(76) Inventor: Robert Barkley Pickup, Beaumaris (AU)

Correspondence Address: LARSON & TAYLOR, PLC, 1199 NORTH FAIRFAX STREET, SUITE 900, ALEXANDRIA, VA, 22314, US

(21) Appl. No.: 10/419,981

(22) Filed: Apr. 22, 2003

(30) Foreign Application Priority Data
Apr. 23, 2002 (AU) PS1932

(51) Int. Cl. G06F 15/173; G06F 15/16

(52) U.S. Cl. 709/225; 709/232

(57) ABSTRACT

A method of authorising electronic mail sent by a sender to a recipient, the method including the steps of: identifying and intercepting an unauthorised electronic mail before delivery to the recipient, the unauthorised electronic mail being identified through a comparison of details of the sender with details contained on a list of authorised senders; and automatically requesting that the sender of the unauthorised electronic mail provide verification in the form of pre-determined information about the recipient before delivery of the electronic mail to the recipient; wherein upon receipt of the verification, the sender is added to the list of authorised senders and the electronic mail is forwarded to the recipient.

### FIELD OF THE INVENTION

The invention broadly relates to a method of and system for authorising electronic mail. The invention particularly but not exclusively relates to a method of authorising electronic mail that utilises a recipient's list of authorised senders.

### BACKGROUND TO THE INVENTION

Spam is defined as unsolicited email, often of a commercial nature, sent indiscriminately to multiple mailing lists, individuals, or newsgroups. It is often referred to simply as “junk” email. The prevalence of “Spamming” (the sending of Spam) over the Internet has increased dramatically in recent years. The problem has reached epidemic proportions with some users receiving hundreds of emails per month or even per week.

In order to combat Spamming, various Spam management systems have been devised. A simple system that operates on a “blacklisting” approach is catered for by a variety of email clients such as Microsoft™ Outlook. When a Spam or junk email is received, the process of blacklisting allows recipients to build up their blacklist by adding the addresses or characteristics of unwanted emails. The blacklist, contained either at the mail server or in the client end software, is provided to crosscheck incoming messages against a list of addresses on the blacklist. Where an address listed on the blacklist is identified then the email having that address is sent to the user's trash or deleted items folder. These blacklists are only reactive in nature; it is necessary to nominate the unwanted address before it can be blocked. Those who are sending Spam (known as “Spammers”) typically avoid this type of blacklisting system by devising clever techniques to mask or modify their Spam to give the appearance that it originates from a different (forged) address.

Another system that has been used to avoid Spam utilises what is known as a “real time” blackhole list which operates on the pretext that Spam originates from the same mail relay. The “real time” blackhole list is a list of known offenders and their mail relays. Unfortunately, the system is still ineffective in preventing or minimising the majority of Spam. One problem with this system is that it still relies on someone recognising and reporting the Spamming mail relay before the Spam is delivered. Hence, not all offending mail relays can be identified. There is also a fundamental problem in that the assumption that all mail from that particular mail relay is Spam may be incorrect. Where this occurs, it may prevent an authentic sender from sending their email through the relay.

I have found that systems for filtering Spam based on the type of explicit deny methods as detailed above have a number of fundamental problems and disadvantages.

It is an object of the present invention to provide a method and system for authorising electronic mail that overcomes or alleviates one or more of the problems present in the prior art.

This discussion of the background to the invention herein is included to explain the context of the invention. This is not to be taken as an admission that any of the material referred to was published, known or part of the common general knowledge as at the priority date of any of the claims.

### SUMMARY OF THE INVENTION

In one aspect, the present invention relates to authorising electronic mail sent by an unauthorised sender to a recipient, the method including the steps of:

identifying and intercepting an unauthorised electronic mail before delivery to the recipient, the unauthorised electronic mail being identified through a comparison of details of the sender with details contained on a list of authorised senders; and

automatically requesting that the sender of the unauthorised electronic mail provide verification before delivery of the electronic mail to the recipient;

wherein upon receipt of the verification, the sender is added to the list of authorised senders and the electronic mail is forwarded to the recipient.

Preferably, the unauthorised electronic mail is intercepted at a mail server associated with the recipient.

The request for verification may be sent to the sender in any suitable manner. In one particularly preferred form, the request for verification is sent to the apparent email address of the sender via email. The request for verification can be in any suitable form. One particularly suitable form is a request provided in non-machine readable form.

Verification can be provided in any suitable manner. In one form of the invention, the sender provides verification by replying with another message. This assists in alleviating the problem where Spam email is sent from a phantom address. In this instance, there will be no reply from the phantom address and hence verification will not occur. In another form of the invention the sender provides verification by providing information about the recipient. This information can be, for example, the recipient's name. Another alternative level of verification can be provided where the sender is required to provide verification by providing one or more of: a password; a PGP key; and a pre-determined token.

Where unauthorised mail is intercepted, the unauthorised electronic mail can be queued for a pre-determined period and deleted if verification is not provided within the period.

In a still further form of the invention, there are a plurality of recipients, and each recipient has a list of authorised senders. In an alternative form to this, a plurality of recipients share the same list of authorised senders.

In another alternative or additional form of the invention, the unauthorised electronic mail is intercepted before entering into a network associated with the recipient. This is advantageous in that it prevents the corresponding reduction in bandwidth caused by unwanted electronic mail passing through the network.

In another alternative or additional form of the invention, the invention includes the further steps of:

identifying a request for verification sent to the recipient; and

forwarding the request for verification message to the recipient without generating a request for verification from the recipient.

This identification of the request for verification (to recipient) may be done in any suitable manner. Ideally, it will need to be done so that spam does not disguise itself as a request for verification. This can be achieved by identifying formatting rules which apply to requests for verification. Alternatively or additionally, the request for verification sent to the recipient can be forwarded only if received within a predetermined time of the recipient sending a message to the sender. This will allow the recipient to “match” requests for verification with emails that they have previously sent.

The present invention may also utilise a request for verification where that request includes non-machine readable code to make it difficult for automated verification of the message.

In a second aspect of the present invention, there is provided a method of updating a whitelist containing details of a recipient's authorised senders, the method including the steps of:

identifying an unauthorised electronic mail, the unauthorised electronic mail being addressed to the recipient and originating from a sender whose details are not included on the whitelist;

forwarding a request for verification to the sender; and

receiving verification from the sender and including the sender's details on the whitelist.

In a third aspect of the present invention, there is provided a method of continuously updating a list of authorised senders to filter unwanted electronic mail, the method including the steps of:

intercepting, at an intermediate destination, an electronic mail addressed to a recipient where details of the sender are not contained on the list of authorised senders;

automatically requesting that the sender provide a verification to confirm their identity; and

receiving verification from the sender and adding the sender to the list of authorised senders and delivering the electronic mail to the recipient.

Preferably, the intermediate destination is a mail server associated with the recipient. In another form of the invention, the intermediate destination is located outside a network associated with the recipient. In one further form of the invention, the request for verification is an electronic mail sent to an address of the sender from the intermediate destination.

The sender may provide verification in any suitable manner. In another form of the invention, the sender provides verification by replying to the mail from the intermediate destination. Verification may also be provided by information about the recipient. This information may, for example, be the recipient's name. A higher level of security (and verification requirements) can be provided by requiring that the sender provide verification by providing one or more of: a password; a PGP key; and a pre-determined token.

Where an unauthorised electronic mail is intercepted, it may be dealt with in any suitable manner. In one form of the invention, the unauthorised electronic mail is queued for a pre-determined period and deleted if verification is not provided within the period.

In another form of the invention, there are a plurality of recipients and each recipient has a list of authorised senders. In an alternative form of the invention, a plurality of recipients share the same list of authorised senders.

In a fourth aspect, the present invention relates to a system for authorising electronic mail sent by an unauthorised sender to a recipient, the system including:

a whitelist containing a list of authorised senders;

identification means for identifying unauthorised electronic mail sent to the recipient, the unauthorised electronic mail being identified by reference to the whitelist;

interception means for intercepting unauthorised email before receipt by the recipient; and

verification means operating, upon detection of an unauthorised email, to send a request for verification to the sender of an unauthorised email;

wherein upon receipt of the verification from the sender, the whitelist is modified to include the sender's details and the electronic mail is forwarded to the recipient.

Preferably, the interception means operates to intercept unauthorised electronic mail before it enters into a network associated with the recipient.

In a fifth aspect, the present invention relates to a mail server for determining authorisation of electronic mail sent by an unauthorised sender to a recipient, the server including

a whitelist;

identification means for identifying unauthorised electronic mail sent to the recipient by reference to the whitelist; and

verification means operating, upon detection of an unauthorised electronic mail, to send a request for verification to the sender of an unauthorised electronic mail;

wherein upon receipt of verification from the sender, the whitelist is modified to include the sender's details and the electronic mail is forwarded to the recipient.

Preferably, the mail server is located outside of a network associated with the recipient

### BRIEF DESCRIPTION OF THE DRAWINGS

The invention will hereinafter be described in greater detail by reference to the attached drawings, which illustrate example forms of the invention. It is to be understood that the particularity of the drawings does not supersede the generality of the preceding description of the invention. In the drawings:

FIG. 1 is a flow chart illustrating the process of intercepting an inbound electronic message.

FIG. 2 is a flow chart illustrating the process of sending an outbound electronic message.

### DETAILED DESCRIPTION

The present invention relates to an advantageous method and system for the prevention of junk electronic mail or Spam. The invention focuses on the use of a whitelist, a list of authorised senders, to minimise or alleviate unsolicited electronic mail. A whitelist facilitates filtering by containing a list of known or allowed senders from which electronic messages may be accepted.

To maintain the spontaneous nature of email, the inventor has proposed a method and system where an automatic process maintains the whitelist whereby only suitably authorised senders are validated and added to the whitelist.

One embodiment of the invention involves a mail server associated with the recipient sending a verifying message to a sender where the mail server has identified that sender as not being on the whitelist. This verifying message is a request that the sender provide verification before the email can be delivered to the recipient's inbox. Where the sender has been verified then the sender's address is added to the whitelist thereby avoiding the need for any verification where further electronic mail is sent from the sender to the recipient.

Verification may be done in any suitable manner. The present invention envisages a number of different types of verification mechanisms to take into account different levels of security for different recipients.

In one embodiment, the verification process occurs by the mail server associated with the recipient forwarding a message to the sender. The sender may then simply reply to that verifying message to achieve verification and inclusion into the recipient's whitelist. This level of verification is particularly suitable where the email address appearing on the Spam is not the address from where the Spam actually originated. In this instance there will be no reply to the verification request and the email will be queued at the server for a predetermined time before being discarded.

Another suitable method of verification involves a process whereby the sender is required to provide specific details on the person to whom they wish to send the email, for example, their full name. For even higher level of Spam protection, the verification can be effected by requiring that the sender provide authorisation in the form of a password, PGP fingerprint or a unique token. In another level of Spam protection, the request for verification can contain an image of non-machine readable text in order to make automated responses from those sending Spam difficult.

Operation of the invention can be explained by reference to the following non-limiting examples.

### EXAMPLE 1

### Transfer of Email Between a Sender and Recipient

A sender sends an electronic mail (email) to a recipient in the standard manner. The mail server associated with the recipient queues the email. The mail server cross-checks the address of the sender with a whitelist associated with the recipient and fails to identify the sender. The mail sever then sends an email to the sender requesting that they supply some form of verification. Upon receipt of the verification at the mail server, the sender is added to the recipient's whitelist and the queued message is forwarded to the recipient's mail spool.

When further emails are sent by the sender to the recipient, the whitelist will be checked and the senders address identified. Consequently, the sender's email will be forwarded to the recipient's mail spool.

### EXAMPLE 2

### Unsucessful Transfer of Email, Forged Email “From:” Address

Where a Spammer sends an email to the recipient, the mail sever intercepts that email and checks whether the sender's name is on the whitelist. The server then sends a verifying message to the forged email address. In this case, the Spammer will never respond because the address has been forged. The email will therefore wait at the mail server for a pre-determined period (without being sent to the recipient) before being deleted. A similar result will occur if the sender's address is not forged but simply consists of an unmanned “drop box”. Where a Spammer develops a mechanism to reply to the verification message (at a great cost to the Spammer), the invention can be implemented with a higher level of verification security.

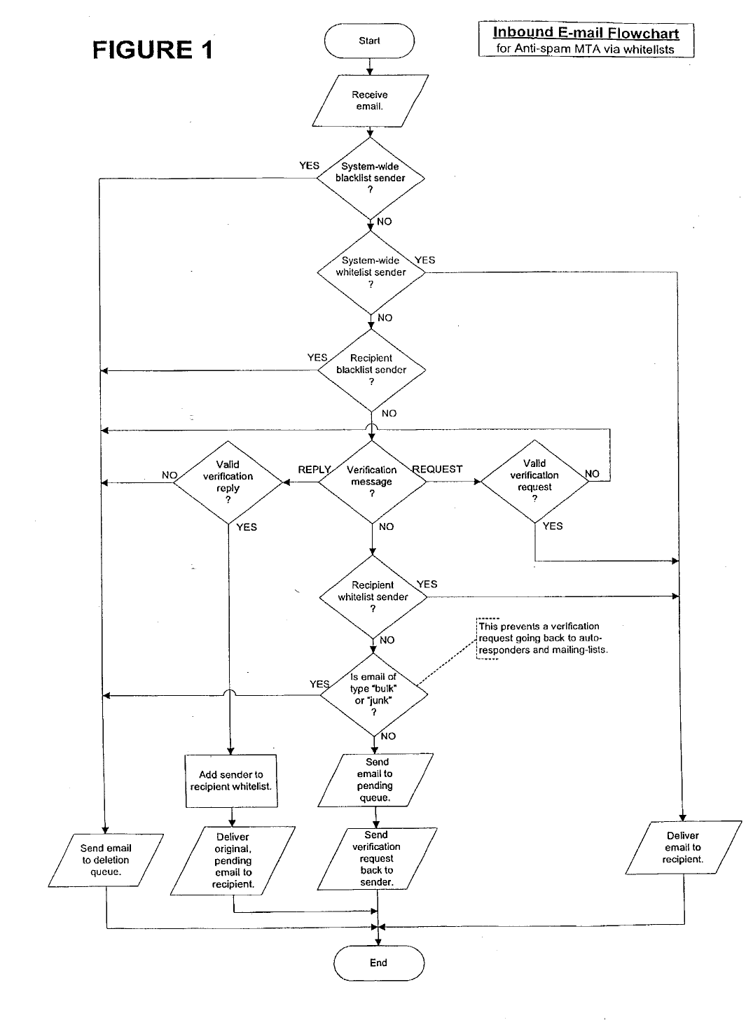

A flowchart illustrating the steps according to one particular embodiment of the present invention is shown in FIG. 1. The email is received at a mail server associated with the recipient. The server then compares the address of the sender with a system wide blacklist, that is a list of senders that have been blacklisted from sending mail to any one of the recipient who receive mail through the particular server. The address of the sender is then compared to a system wide whitelist. Where the sender's address is contained on that list then it is delivered directly to the recipient. The sender's address is then compared to a blacklist compiled by the sender. If it appears on this list then it is forwarded to a message deletion queue. Finally, the address of the sender is compared to a whitelist of the recipient, if it is contained on this list then it is forwarded to the recipient. If the sender's address is not on this list then a verification message is sent to the sender and when (and if) verification is received then the sender is added to the recipient's whitelist and the sender's email is forwarded to the recipient.

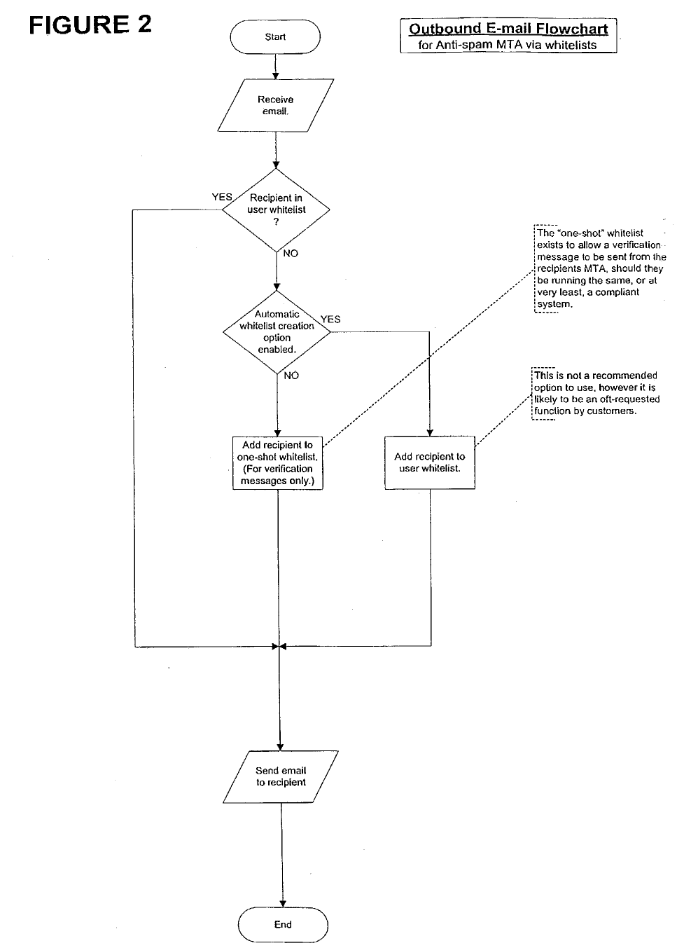

In another embodiment of the invention, the email is received at a mail server associated with the recipient. The server compares the address of the sender with a whitelist. If the senders address is on the whitelist then the mail is forwarded onto the recipient. To automatically update the whitelist, the recipient can utilise the automatic updating mechanism of the present invention. This operates by sending an email message to the sender requesting that the sender provide verification signalling that they are authorised to send an email to the recipient. Where verification is received, the sender is added to the recipient's whitelist and further emails from the sender can be delivered to the recipient without the requirement for a verification step.

Where both the sender and the recipient are utilising the present invention, the verification must be allowed to pass through to the sender without causing another verification message in the opposing direction. This may be accomplished in a variety of ways. For example, verification messages can be identified by strict formatting rules (to prevent Spam electronic mail masquerading as a verification message). Another method of receiving a verification message can occur where the sender expects a verification message shortly after a local electronic mail has been sent out of the sender's system. A flowchart illustrating the sending of an outbound verification message according to one particular embodiment of the present invention is shown in FIG. 2. In the flowchart shown in this figure, the sender's electronic mail whitelist is specifically set up to ensure that it can receive verification messages from recipients utilising the present invention.

The present invention can be utilised in a manner whereby unwanted email is prevented, by the whitelist, from entering the network. This can be accomplished by using a global whitelist that effectively identifies unauthorised electronic mail before it is forwarded to the recipient. This overcomes the disadvantage with many current electronic mail systems where the email enters the network and is stored in the junk mail folder. Where this occurs, there is a corresponding increase in bandwidth and storage costs. This can be avoided by utilising a whitelist which operates on a global scale effectively intercepting and seeking authorisation from unauthorised senders before entry of the electronic message into the network.

In one embodiment of the invention, delaying all messages from local queuing until after successful verification can potentially save bandwidth and disk space resources. This can be achieved by replying with an error code 4xx in SMTP negotiation at the primary Mail Exchanger (MX), after determining sender and recipient, but without accepting the entire message.

A particular advantage of the present invention is that it maintains the ability of a sender to send and electronic mail message from any previously unknown person to any other person on the Internet (subject to verification). The invention is also beneficial in that implementation can be immediate without requiring global adoption of the system.

It is to be understood that various alterations, additions and/or modifications may be made to the parts previously described without departing from the ambit of the invention.

The claims defining the invention are as follows:

1. A method of authorising electronic mail sent by a sender to a recipient, the method including the steps of:
(a) identifying and intercepting an unauthorised electronic mail before delivery to the recipient, the unauthorised electronic mail being identified through a comparison of details of the sender with details contained on a list of authorised senders; and
(b) automatically requesting that the sender of the unauthorised electronic mail provide verification before delivery of the electronic mail to the recipient; wherein upon receipt of the verification, the sender is added to the list of authorised senders and the electronic mail is forwarded to the recipient.

2. A method according to claim 1, wherein the unauthorised electronic mail is intercepted at a mail server associated with the recipient.

3. A method according to claim 1, wherein the request for verification is an electronic message sent to an address of the sender.

4. A method according to claim 3, wherein the electronic message includes non-machine readable code.

5. A method according to claim 3, wherein the sender provides verification by replying with another electronic mail.

6. A method according to claim 1, wherein the sender provides verification by providing information about the recipient.

7. A method according to claim 6, wherein the information is the recipient's name.

8. A method according to claim 1 , wherein the sender provides verification by providing one or more of:
(a) a password;
(b) a PGP key; and
(c) a pre-determined token.

9. A method according to claim 1, wherein unauthorised electronic mail is queued for a pre-determined period and deleted if verification is not provided within the period.

10. A method according to claim 1, wherein there are a plurality of recipients and each recipient has a list of authorised senders.

11. A method according to claim 1, wherein there are a plurality of recipients who share the same list of authorised senders.

12. A method according to claim 1, further including the step of:
(a) identifying a request for verification sent to the recipient; and
(b) forwarding the request for verification message to the recipient without generating a request for verification.

13. A method according to claim 12, wherein the request for verification is identified by formatting rules.

14. A method according to claim 12, wherein the request for verification sent to the recipient is only forwarded if received within a pre-determined time of the recipient sending a message to the sender.

15. A method of updating a whitelist containing details of a recipient's authorised senders, the method including the steps of:
(a) identifying an unauthorised electronic mail, the unauthorised electronic mail being addressed to the recipient and originating from a sender whose details are not included on the whitelist; and
(b) forwarding a request for verification to the sender; and
(c) receiving verification from the sender and including the sender's details on the whitelist.

16. A method of continuously updating a list of authorised senders, the method including the steps of:
(a) intercepting, at an intermediate destination, an electronic message addressed to a recipient where details of the sender are not contained on the list of authorised senders;
(b) automatically requesting that the sender provide a verification to confirm their identity; and
(c) receiving verification from the sender and adding the sender to the list of authorised senders and delivering the email to the recipient.

17. A method according to claim 16, wherein the intermediate destination is a mail server associated with the recipient.

18. A method according to claim 16, wherein the request for verification is an electronic message sent to an address of the sender from the intermediate destination.

19. A method according to claim 18, wherein the sender provides verification by replying to the message from the intermediate destination.

20. A method according to any one of claim 15 , wherein the sender provides verification by providing information about the recipient.

21. A method according to claim 20, wherein the information is the recipient's name.

22. A method according to claim 15, wherein the sender provides verification by providing one or more of:
(a) a password;
(b) a PGP key; and
(c) a pre-determined token.

23. A method according to claim 15, wherein the electronic message is queued for a pre-determined period and deleted if verification is not provided within the period.

24. A method according to claim 15, wherein there are a plurality of recipients, and each recipient has a list of authorised senders.

25. A method according to claim 18, wherein the electronic message includes non-machine readable code.

26. A method according to claim 15, wherein a plurality of recipients share the same list of authorised senders.

27. A system for authorising electronic mail sent by an unauthorised sender to a recipient, the system including:
(a) a whitelist containing a list of authorised senders;
(b) identification means for identifying unauthorised electronic mail sent to the recipient, the unauthorised electronic mail being identified by reference to the whitelist;
(c) interception means for intercepting unauthorised electronic mail before receipt by the recipient; and
(d) verification means operating, upon detection of an unauthorised email, to send a request for verification to the sender of an unauthorised electronic mail;
wherein upon receipt of the verification from the sender, the whitelist is modified to include the sender's details and the electronic mail is forwarded to the recipient.

28. A mail server for determining authorisation of electronic mail sent by an unauthorised sender to a recipient, the server including
(a) a whitelist;
(b) identification means for identifying unauthorised electronic mail sent to the recipient by reference to the whitelist; and
(c) verification means operating, upon detection of an unauthorised electronic mail, to send a request for verification to the sender of an unauthorised mail;
wherein upon receipt of verification from the sender, the whitelist is modified to include the sender's details and the electronic mail is forwarded to the recipient.

29. A method according to claim 1, wherein the unauthorised electronic mail is intercepted before entering into a network associated with the recipient.

30. A method according to claim 16, wherein the intermediate destination is located outside a network associated with the recipient.

31. A system according to claim 27, wherein the interception means operates to intercept unauthorised electronic mail before it enters into a network associated with the recipient.

32. A mail server according to claim 28, wherein the mail server is located outside of a network associated with the recipient.

33. A method of authorising electronic mail sent by a sender to a recipient, the method including the steps of:
(a) identifying and intercepting an unauthorised electronic mail before delivery to the recipient, the unauthorised electronic mail being identified through a comparison of details of the sender with details contained on a list of authorised senders; and
(b) automatically requesting that the sender of the unauthorised electronic mail provide verification in the form of pre-determined information about the recipient before delivery of the electronic mail to the recipient;
wherein upon receipt of the verification, the sender is added to the list of authorised senders and the electronic mail is forwarded to the recipient.

34. A method according to claim 33, wherein the pre-determined information about the recipient is personal information pertaining to the recipient.

35. A method according to claim 34, wherein the person information is the recipient's name.
